(19) United States
(12) Patent Application Publication
(10) Pub. No.: US 2013/0192057 A1
(43) Pub. Date: Aug. 1, 2013

(54) MANUFACTURING METHOD FOR COIL UNIT

(71) Applicant: Kiyotaka KOGA, Nishio (JP)

(72) Inventor: Kiyotaka KOGA, Nishio (JP)

(21) Appl. No.: 13/713,366

(22) Filed: Dec. 13, 2012

(30) Foreign Application Priority Data
Jan. 31, 2012 (JP) 2012-018990

(51) Int. Cl. H02K 3/04

(52) U.S. Cl. CPC H02K 3/04
USPC 29/596

(57) ABSTRACT

A method for manufacturing a coil unit includes inserting a coil conductor wire into a slot from a slot opening portion with a circumferential wire width of the coil conductor wire equal to or less than a slot opening width, the slot opening width being a width of the slot opening portion in the circumferential direction, the circumferential wire width being a wire width of the coil conductor wire in a direction parallel with the slot opening width, the coil conductor wire being a conductor wire with a deformable cross-sectional shape, and a diameter of the coil conductor wire with a circular cross-sectional shape being larger than the slot opening width; and pressing the coil conductor wire inserted into the slot in a depth direction which is opposite to the opening direction to deform the cross-sectional shape of the coil conductor wire.

### INCORPORATION BY REFERENCE

The disclosure of Japanese Patent Application No. 2012-018990 filed on Jan. 31, 2012 including the specification, drawings and abstract is incorporated herein by reference in its entirety.

### BACKGROUND OF THE INVENTION

The present invention relates to a method for manufacturing a coil unit that forms a stator or a rotor of a rotary electric machine, in which a coil conductor wire is wound around a core having a plurality of slots disposed in a distributed manner in the circumferential direction of a cylindrical core reference surface.

### Description of the Related Art

A stator or a rotor provided in a rotary electric machine serving as an electric motor or an electric generator to function as an armature is formed by attaching coils to a core (a stator core or a rotor core) having a plurality of slots. For example, a stator formed as an armature has coils, which are formed by winding a conductor wire with a circular cross section in a multiplicity of turns, in a plurality of slots disposed in a distributed manner in the circumferential direction of a stator core. With a conductor wire with a circular cross section, however, gaps tend to be formed between conductor wires in the slots in attaching the conductor wires to the stator, which makes it difficult to enhance the space factor of the coils. In order to enhance the space factor by reducing the gaps between the conductor wires, it is effective to reduce the diameter of the conductor wires. In the case where the diameter of the conductor wires is reduced, however, it may be necessary to make contrivances not to cause a wire breakage in winding the conductor wires around the core, or the number of turns of the conductor wires to be wound around the core may be increased, which may require longer time for a winding process. In order to enhance the space factor, meanwhile, it is also effective to form coils using a conductor element wire with a rectangular cross section. In this case, however, the shape of the slots is also limited to a shape corresponding to the cross-sectional shape of the conductor wire, and the slots or teeth may not necessarily have an optimum shape.

Japanese Patent Application Publication No. 2002-125338 (JP 2002-125338 A) describes a technology in which a conductor wire with a circular cross-sectional shape is mounted in slots and thereafter pressed such that the cross-sectional shape of the conductor wire is shaped into a rectangular shape to improve the space factor of coils. Meanwhile, Japanese Patent Application Publication No. 2011-91943 (JP 2011-91943 A) describes use of a conductor wire with a deformable cross-sectional shape obtained by bundling up a plurality of conductors to form a conductor bundle and covering the conductor bundle with an insulator. In JP 2011-91943 A, the conductor wire wound around a dividable core which can be divided for each tooth is shaped into a desired coil shape using shaping dies.

The technologies disclosed in JP 2002-125338 A and JP 2011-91943 A are excellent in improving the space factor of coils. Examples of the shape of the slot include a so-called semi-open slot in which the circumferential width of an opening portion of the slot is narrower than the circumferential width of the internal space of the slot. In the case of an open slot (full-open slot) in which the circumferential width of an opening portion of the slot is the same as the circumferential width of the internal space of the slot as in JP 2002-125338 A, the conductor wire can be inserted into the slot from the radial direction. For the semi-open slot, however, it is necessary that the conductor wire should be inserted into the slot from the axial direction. Therefore, a single conductor wire may not be wound continuously. This may raise the need to weld divided conductor wires to each other at a plurality of points, which may increase the number of man-hours, increase a loss due to such welding, and impede a reduction in size of a rotary electric machine in the case where there are a large number of such welding points. In addition, while the technology according to JP 2011-91943 A can be applied to the split core, it is difficult to apply the technology according to JP 2011-91943 A to an integrated core formed in a cylindrical shape, for example.

### SUMMARY OF THE INVENTION

In view of the foregoing background, it is desirable to provide a technology for forming a stator or a rotor of a rotary electric machine by winding a coil conductor wire with a high space factor around a core having a plurality of slots disposed in a distributed manner in the circumferential direction of a cylindrical core reference surface.

In view of the foregoing issue, an aspect of the present invention provides a manufacturing method for a coil unit that forms a stator or a rotor of a rotary electric machine, that is,

a manufacturing method for a coil unit that forms a rotary electric machine, in which a coil conductor wire is wound around a core, the core having a plurality of slots disposed in a distributed manner in a circumferential direction of a cylindrical core reference surface, the slots each having a slot opening portion that opens in an opening direction toward one side in a radial direction of the core reference surface, the method including:

an insertion step of inserting the coil conductor wire into the slot from the slot opening portion with a circumferential wire width of the coil conductor wire equal to or less than a slot opening width, the slot opening width being a width of the slot opening portion in the circumferential direction, the circumferential wire width being a wire width of the coil conductor wire in a direction parallel with the slot opening width, the coil conductor wire being a conductor wire with a deformable cross-sectional shape, and a diameter of the coil conductor wire with a circular cross-sectional shape being larger than the slot opening width; and

a pressing step of pressing the coil conductor wire inserted into the slot a depth direction which is opposite to the opening direction to deform the cross-sectional shape of the coil conductor wire.

According to the manufacturing method, the coil conductor wire, the diameter of which is larger than the slot opening width in the case where the cross-sectional shape of the coil conductor wire is circular, is inserted into the slot, from the slot opening portion with the circumferential wire width of the toil Conductor wire equal to or less than the slot opening width. Thus, a conductor wire with a large wire diameter can be used as the coil conductor wire. In addition, the number of conductor wires in the slot is reduced, thereby decreasing the amount of insulating covering in the slot to enhance the space factor of the conductor wires. Further, the possibility of a wire breakage and an increase in number of turns of the conductor wires to be wound around the core are suppressed. That is, according to the above-described configuration, it is possible to form a stator or a rotor of a rotary electric machine by forming a coil unit by winding the coil conductor wire with a high space factor around the core having the plurality of slots disposed in a distributed manner in the circumferential direction of the cylindrical core reference surface.

In the insertion step, as described above, the coil conductor wire is inserted into the slot from the slot opening portion with the circumferential wire width of the coil conductor wire equal to or less than the slot opening width. Thus, a step in which the circumferential wire width of the coil conductor wire is deformed may be performed prior to the insertion step. In one aspect, the manufacturing method for a coil unit according to the present invention may further include a flattening step of deforming the coil conductor wire such that the wire width of the coil conductor wire in at least one direction corresponding to the circumferential wire width becomes equal to or less than the slot opening width, the flattening step being performed prior to the insertion step.

Here, in one aspect, the pressing step of the manufacturing method for a coil unit according to the present invention may include deforming the cross-sectional shape of the coil conductor wire such that the circumferential wire width becomes larger than the circumferential wire width at a tune of insertion into the slot opening portion in the insertion step. According to the aspect, the cross-sectional shape of the coil conductor wire is deformed such that the circumferential wire width becomes larger than that at a time of insertion into the slot opening portion. That is, the coil conductor wire is widened in the circumferential direction inside the slot, thereby reducing the gap between an inner wall of the slot and the coil conductor wire to enhance the space factor. In addition, with the circumferential wire width of the coil conductor wire widened, the radial wire width of the coil conductor wire is reduced. This accordingly allows insertion of the coil conductor wires into the slot, thereby enhancing the space factor.

Examples of the shape of the slot include a so-called semi-open slot in which the slot opening width is narrower than the circumferential width of the internal space of the slot. In the case of a semi-open slot, if the coil conductor wire is pressed such that the circumferential wire width of the coil conductor wire inserted into the internal space of the slot is larger than the slot opening width, the space factor of the coil conductor wires in the slot can be enhanced. That is, in one aspect of the manufacturing method for a coil unit according to the present invention, in the case where the slot has an internal space that is wider in the circumferential direction on a side in the depth direction with respect to the slot opening portion than at the slot opening portion, the pressing step may include deforming the cross-sectional shape of the coil conductor wire such that the circumferential wire width of the coil conductor wire is larger than the slot opening width.

The slot opening width is smaller than the diameter of the coil conductor wire with a circular cross-sectional shape. In the case of a semi-open slot in which the slot opening width is narrower than the circumferential width of the internal space of the slot, the coil conductor wire may be pressed such that the circumferential width of the coil conductor wire inserted into the internal space of the slot becomes larger than the diameter of the coil conductor wire with a circular cross-sectional shape to enhance the space factor. That is, in one aspect of the manufacturing method for a coil unit according to the present invention, in the case where the slot has an internal space that is wider in the circumferential direction on a side in the depth direction with respect to the slot opening portion than at the slot opening portion, the pressing step may include deforming the cross-sectional shape of the coil conductor wire such that the circumferential wire width in the slot is larger than the diameter of the coil conductor wire with a circular cross-sectional shape.

Here, the coil conductor wire used in the manufacturing method for a coil unit according to the aspect of the present invention may be a conductor wire including a conductor element wire bundle formed by gathering a plurality of conductor element wires and a flexible insulating covering material that covers a periphery of the conductor element wire bundle, and a shape of the insulating covering material in cross section taken in an orthogonal extending plane may be deformable, the orthogonal extending plane being orthogonal to an extending direction of the conductor element wire bundle. Here, the periphery of the conductor element wire bundle refers to the periphery of the conductor element wire bundle in cross section taken in the orthogonal extending plane. With the insulating covering material flexible, the cross-sectional shape of an aggregated covered wire (a conductor wire including a conductor element wire bundle and an insulating covering material that covers the conductor element wire bundle) with a maximum deformable range is flexibly deformable from a circular shape. Therefore, the manufacturing method for a coil unit according to the aspect of the present invention is suitable for the properties of the coil conductor wire.

Further, the coil conductor wire with a flexible insulating covering material may have an in-covering gap provided radially inwardly of the insulating covering material to make the conductor element wires movable relative to each other. With the insulating covering material flexible and with the in-covering gap provided radially inwardly of the insulating covering material, the conductor element wires are movable relative to each other in the in-covering gap. Thus, the shape of the conductor wire in cross section taken in the orthogonal extending plane can be deformed relatively freely even in the case where the insulating covering material is not highly elastic. Therefore, the manufacturing method for a coil unit according to the aspect of the present invention is suitable for the properties of the coil conductor wire.

In order to press the coil conductor wire inserted into the slot, it is necessary that the circumferential width of a jig insertable in the radial direction from the slot opening portion should be smaller than the slot opening width. Here, in the case of a semi-open slot in which the slot opening width is narrower than the circumferential width of the internal space of the slot, the circumferential wire width of the coil conductor wire can be widened to a width that is wider than the circumferential width of the jig. In this event, in order to sufficiently apply a pressing force from the jig to the coil conductor wire, the width of at least a portion of the jig that contacts the coil conductor wire may be larger than the slot opening width. It should be noted, however, that it is difficult to insert such a jig from the slot opening portion in the radial direction.

It is necessary that at least the portion of the jig that contacts the coil conductor wire should be inserted into the slot from the axial direction. In one aspect of the manufacturing method for a coil unit according to the present invention, in the case where the slot has an internal space that is wider in the circumferential direction on a side in the depth direction with respect to the slot opening portion than at the slot opening portion, the pressing step may include inserting a pressing jig that is wider in the circumferential direction than the slot opening portion into the slot along an axial direction of the core reference surface, and thereafter pressing the coil conductor wire in the depth direction.

As described above, a force in the circumferential direction is applied to the coil conductor wire to deform the cross-sectional shape of the coil conductor wire when the coil conductor wire is inserted into the slot, that is, when the coil conductor wire passes through the slot opening portion, and a force in the radial direction (depth direction) is applied to the coil conductor wire to deform the cross-sectional shape of the coil conductor wire after the coil conductor wire is inserted into the slot. In order to enhance the space factor of the coil conductor wire inside the slot, it is important that the cross-sectional shape of the coil conductor wire should be reliably deformed in two stages. In one aspect of the manufacturing method for a coil unit according to the present invention, the insertion step may include inserting a plurality of the coil conductor wires one at a time into the slot such that the plurality of coil conductor wires are stacked in the radial direction of the core reference surface in the slot. Here, the term “plurality of the coil conductor wires” is not limited to a plurality of independent coil conductor wires. It is a matter of course that the term “plurality of the coil conductor wires” includes a state in which portions of one coil conductor wire that are connected to each other outside the slot (continuous) are provided in the same slot.

### BRIEF DESCRIPTION OF THE DRAWINGS

FIG. 1 is a perspective view of a rotary electric machine according to an embodiment;

FIG. 2 is a partial enlarged sectional view of a stator;

FIG. 3 is a perspective view showing the structure of a conductor wire;

FIG. 4 is a cross-sectional view showing the structure of the conductor wire;

FIG. 5 is an illustration showing an example of the relationship between the circumferential width of a slot and the wire width of the conductor wire;

FIG. 6 is a flowchart showing an example of a manufacturing method for the stator as a coil unit;

FIG. 7 is an illustration showing manufacturing steps for one slot;

FIG. 8 is an illustration showing another example of the relationship between the circumferential width of the slot and the wire width of the conductor wire;

FIG. 9 is an illustration showing another example of the relationship between the circumferential width of the slot and the wire width of the conductor wire;

FIG. 10 is an enlarged sectional view showing an example of a parallel slot and a parallel tooth;

FIG. 11 is an illustration showing another example of the relationship between the circumferential width of the slot and the wire width of the conductor wire;

FIG. 12 is an illustration showing another example of the relationship between the circumferential width of the slot and the wire width of the conductor wire;

FIG. 13 is an imaginary cross-sectional view of the conductor wire for explaining an in-coveting gap; and

FIG. 14 is an imaginary cross-sectional view of the conductor wire for explaining the in-covering gap.

### DETAILED DESCRIPTION OF THE EMBODIMENTS

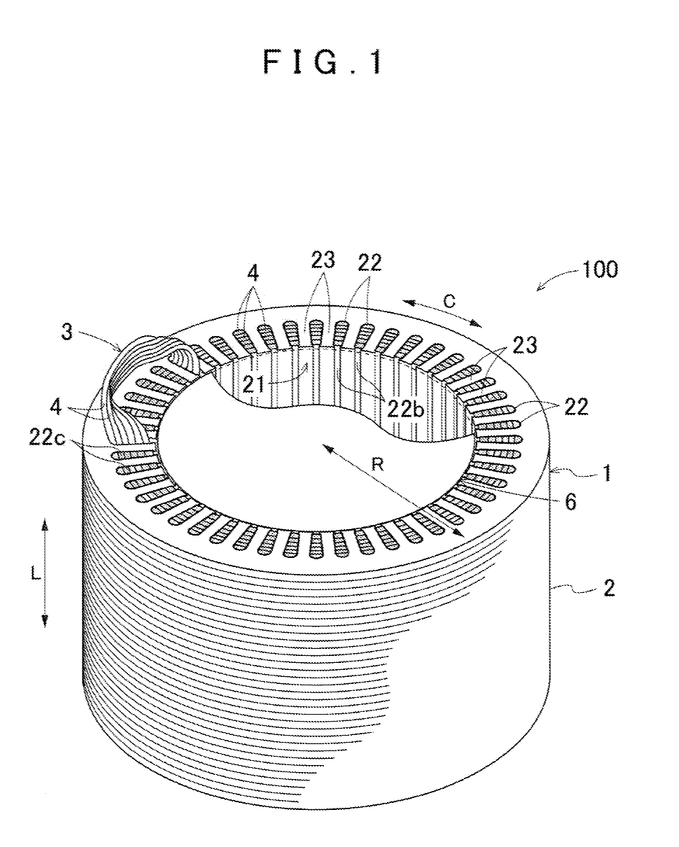

An embodiment of the present invention will be described below with reference to the drawings. Here, the present invention is described as being applied to a rotary electric machine 100 of an inner rotor type as shown in FIG. 1. Unless otherwise noted, the terms “axial direction L”, “circumferential direction C”, and “radial direction R” as used herein are defined with reference to the axis of a cylindrical core reference surface 21 of a stator core 2 to be described later (for example, the inner circumferential surface of the stator core 2) (see FIG. 1).

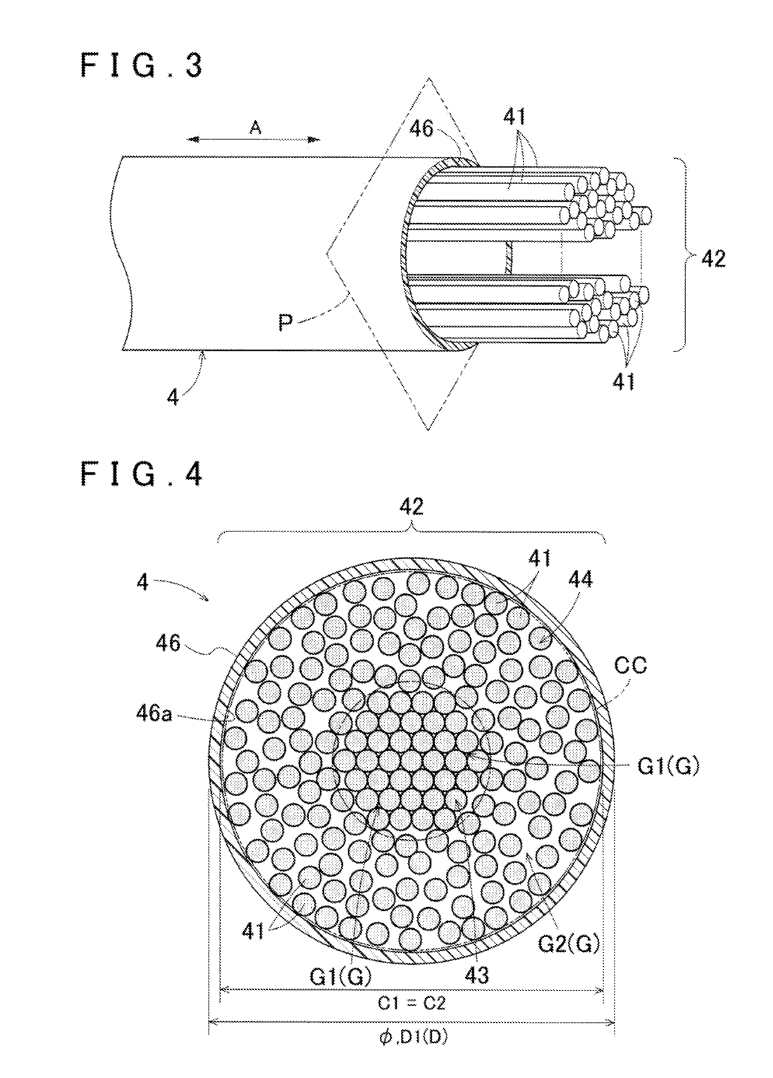

A conductor wire 4 (coil conductor wire) that forms a coil 3 (stator coil) in a stator 1 of the rotary electric machine 100 has a deformable cross-sectional shape. In the present embodiment, as shown in FIG. 3, the conductor wire 4 includes a conductor element wire bundle 42 formed by gathering a plurality of conductor element wires 41, and a flexible insulating covering material 46 that covers the periphery of the conductor element wire bundle 42. That is, the conductor wire 4 has a structure in which the periphery of the conductor element wire bundle 42, which is formed by gathering a plurality of conductor element wires 41, is covered with the flexible insulating covering material 46. In the present embodiment, a manufacturing method for a coil unit that forms a rotary electric machine using the conductor wire 4 is described. Specifically, the rotary electric machine 100 with a coil unit serving as an armature (which is a stator or a rotor, and which is the stator 1 in the present embodiment) formed using the conductor wire 4 is described.

First, the overall configuration of the rotary electric machine 100 according to the present embodiment will be described. As shown in FIG. 1, the rotary electric machine 100 includes the stator 1 and a rotor 6 provided inwardly of the stator 1 in the radial direction R so as to be rotatable. The stator 1 includes the stator core 2 and the coil 3 (stator coil) attached to the stator core 2. In the present embodiment. the coil 3 is formed using the conductor wire 4. In FIG. 1, in order to avoid complication, coil end portions corresponding to portions of the coil 3 that project from the stator core 2 in the axial direction L are not shown except for coil end portions that project from a pair of slots 22. In FIG. 1, the cross sections of a plurality of conductor wires 4 forming the coil 3 are shown at end portions of the remaining slots 22 in the axial direction L. In FIG. 1, in addition, a part of the rotor 6 is depicted as being transparent.

The stator core 2 (core) is formed of a magnetic material. The stator core 2 can be formed as a laminated structure in which a plurality of annular magnetic steel plates are laminated on each other, or using a compacted powder material formed from powder of a magnetic material by pressure forming as a main constituent element, for example. The stator core 2 has a plurality of slots 22 in which the conductor wire 4 can be wound. Here, the slots 22 have a space extending in the axial direction L of the cylindrical core reference surface 21 of the stator core 2, and the plurality of slots 22 are disposed in a distributed manner in the circumferential direction C of the core reference surface 21. In addition, the plurality of slots 22 is formed radially from the axis of the stator core 2 such that each slot has a space extending in the radial direction R. The “cylindrical core reference surface 21” refers to an imaginary surface serving as a reference for the arrangement and configuration of the slots 22. In the present embodiment, as shown in FIG. 1, the core reference surface 21 is a core inner circumferential surface which is an imaginary cylindrical surface including inner end surfaces of a plurality of teeth 23 in the radial direction R, the teeth 23 each being formed between two adjacent slots 22. A cylindrical surface (including an imaginary strike) which is concentric with the cylindrical core inner circumferential surface and whose cross-sectional shape as viewed in the axial direction L (as seen along the axial direction L) is analogous to the cross-sectional shape of the core inner circumferential surface as viewed in the axial direction L may also serve as the “cylindrical core reference surface 21” according to the present invention. In the present embodiment, as shown in FIG. 1, the stator core 2 is formed in a cylindrical shape, and therefore the outer circumferential surface of the stator core 2 may also be defined as the “cylindrical core reference surface 21”, for example.

The stator core 2 has the plurality of slots 22 disposed in a distributed manner at constant intervals along the circumferential direction C. The plurality of slots 22 has the same shape as each other. In addition, the stator core 2 has a slot opening portion (“radial opening portion 22b” to be described later) at which each of the slots 22 opens in an opening direction toward one side in the radial direction R of the core reference surface 21. Specifically, the stator core 2 has a slot opening portion that opens in an opening direction either inward (toward the axis) or outward (toward the outer circumference) in the radial direction R of the core reference surface 21. The conductor wire 4 is wound around such a stator core 2A to manufacture a coil unit.

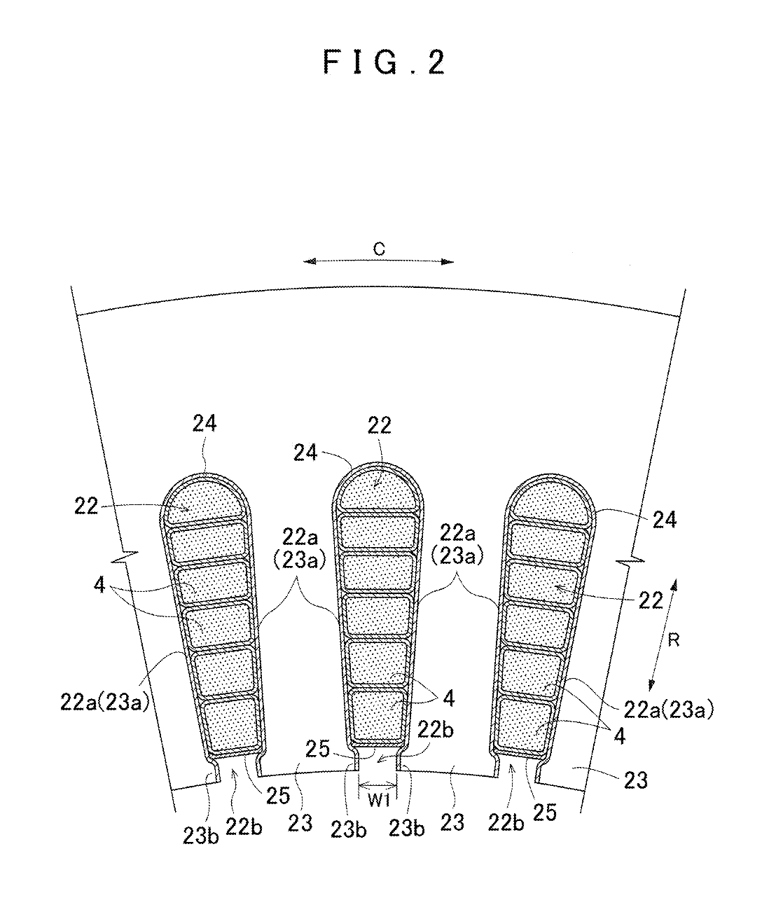

As described above, the stator core 2 has the plurality of teeth 23 each formed between two slots 22 that are adjacent to each other in the circumferential direction C. As shown in FIG. 2, a circumferential projecting portion 23b that projects in the circumferential direction C with respect to the remaining portion (portion on the outer side in the radial direction R with respect to the distal end portion) of a tooth side surface 23a is formed at the distal end portion of each tooth 23. In the present embodiment, as shown in FIG. 2, two tooth side surfaces 23a of each tooth 23 that face in opposite directions along the circumferential direction C are mostly formed to be parallel with each other except for stepped portions that form the circumferential projecting portions 23b. As is clear from FIG. 2, the two tooth side surfaces 23a are disposed in parallel with each other in a direction along the radial direction R. That is, the teeth 23 are formed as parallel teeth.

In other words, the slots 22 which have a space extending in the axial direction L and the radial direction R are formed in the shape of a groove having a predetermined width in the circumferential direction C. In addition, the slots 22 are each formed between adjacent parallel teeth, and therefore each slot 22 is formed such that the width of the slot 22 in the circumferential direction C becomes gradually wider outward in the radial direction R. That is, an inner wall surface 22a of each slot 22 has two flat surfaces facing each other in the circumferential direction C and formed such that the spacing therebetween becomes wider outward in the radial direction R, and a curved surface with an arcuate cross section formed outward in the radial direction R of the two flat surfaces and extending in the axial direction L. In addition, each slot 22 is formed to have the radial opening portion 22b (see FIG. 2) and an axial opening portion 22c (see FIG. 1). Here, as shown in FIG. 2, the radial opening portion 22b is a portion that opens inward in the radial direction R of the stator core 2 (in the inner circumferential surface of the stator core 2 corresponding to the core reference surface 21). As shown in FIG. 1, in addition, the axial opening portion 22c is a portion that opens toward both sides in the axial direction L of the stator core 2 (in both end surfaces in the axial direction). A slot insulating portion 24 is provided on the inner wall surface 22a of the slot 22. In the present embodiment. insulating powder coating is applied to the entire inner wall surface 22a, and the slot insulating portion 24 is formed from a film applied by the insulating powder coating.

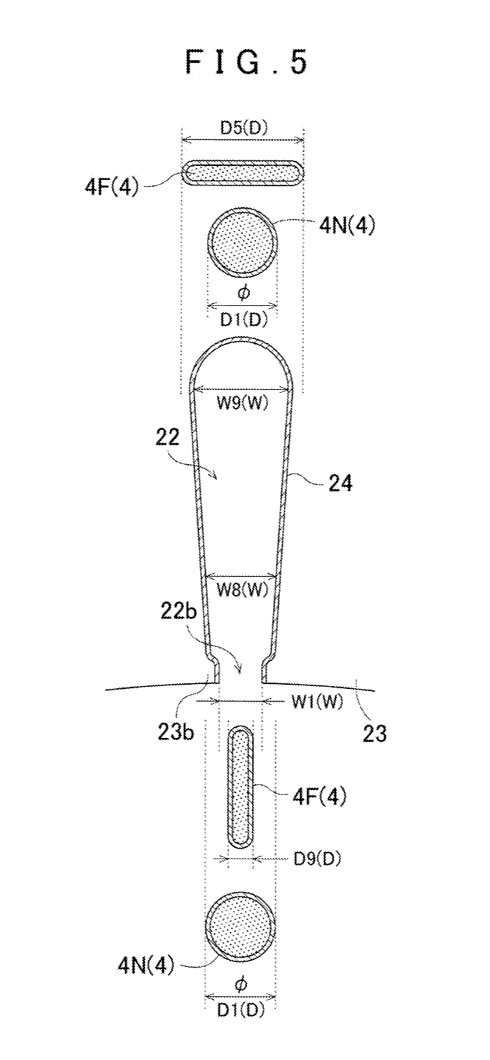

As described above, the circumferential projecting portion 23b is provided at the distal end portion of each tooth 23, and thus the opening width (slot opening width W1) of the radial opening portion 22b of each slot 22 is narrow compared to a portion on the side in the depth direction of the slot 22 (on the outer side in the radial direction R) with respect to a portion at which the circumferential projecting portions 23b face each other. Here, the slot opening width W1 is the width of the radial opening portion 22b in the circumferential direction C, that is, the width in a direction orthogonal to the radial direction R. That is, as shown in FIG. 2, the slot opening width W1 is the width of the radial opening portion 22b (slot opening portion) in a plane orthogonal to the axial direction L of the stator 1. As shown in FIG. 2, the slot opening width W1 of each slot 22 is narrower than the width of the slot 22 in the circumferential direction C (“slot width W” to be described later on the basis of FIG. 5) at a portion at which the conductor wire 4 is disposed. In other words, the slot 22 has an internal space that is wider in the circumferential direction on the side in the depth direction with respect to the radial opening portion 22 (slot opening portion) than at the radial opening portion 22b. That is the stator core 2 according to the present embodiment is formed to have semi-open slots 22. As a matter of course, such semi-open slots 22 are shaped such that a maximum slot width W9 (see FIG. 5) which is the maximum value of the slot width W in the circumferential direction C is larger than the slot opening width W1.

In the present embodiment, the rotary electric machine 100 is a 3-phase AC electric motor or a 3-phase AC electric generator driven by 3-phase AC (U-phase, V-phase, and W-phase). Thus, the coil 3 (stator core) of the stator 1 is divided into a U-phase coil, a V-phase coil, and a W-phase coil corresponding to the three phases (U-phase, V-phase, and W-phase). Therefore, in the stator core 2, slots 22 for U-phase, V-phase, and W-phase are disposed so as to repeatedly appear along the circumferential direction C. As described above, the rotary electric machine 100 according to the present embodiment is of an inner rotor type, and the rotor 6 including permanent magnets or electromagnets (not shown) and serving as a field is disposed inwardly of the stator 1 serving as an armature in the radial direction R so as to be rotatable relative to the stator 1. That is, the rotary electric machine 100 is a rotary electric machine of a rotating field type in which the rotor 6 is rotated by a rotating field generated by the stator 1.

In the present embodiment, two U-phase slots for insertion of U-phase coils, two V-phase slots for insertion of V-phase coils, and two W-phase slots for insertion of W-phase coils are disposed in the stator core 2 such that the slots repeatedly appear along the circumferential direction C in the order in which they are mentioned and the number of slots for each pole of the field and each of the three phases (for each pole and each phase) is “2”. The number of slots for each pole and for each phase is appropriately changeable, and may be “1”, “3”, etc., for example. In addition, the number of phases of an AC power supply that drives the rotary electric machine 100 is also appropriately changeable, and may be “1”, “2”, “4”, etc., for example. In addition, a variety of methods known in the art may be used to wind the conductor wire 4 around the stator core 2. For example, the conductor wire 4 may be wound around the stator core 2 using a combination of one of lap winding and wave winding and one of concentrated winding and distributed winding to form the stator 1 (coil unit).

As shown in FIG. 1, a plurality of conductor wires 4 accommodated in one slot 22 project from an end portion of the stator core 2 in the axial direction L and extend in the circumferential direction C to be accommodated in another slot 22. In the illustrated example, the stator core 2 has 48 slots 22 distributed in the circumferential direction C, and the number of slots for each pole and each phase is set to “2”. The conductor wires 4 in a first slot 22 are connected to the conductor wires 4 in a second slot 22 which is disposed 6 slots away from the first slot 22. While FIG. 1 shows only portions of the conductor wires 4 that connect between a pair of slots 22, such portions of the conductor wires 4 are also provided for the other slots 22. That is, in practice, the conductor wires 4 projecting from the stator core 2 in the axial direction L are disposed so as to extend in the circumferential direction C to connect between the slots 22. The conductor wires 4 projecting from the stator core 2 in the axial direction L form coil end portions. The specific arrangement and configuration of the conductor wires 4 in such coil end portions differ depending on the specific method of winding the coil 3 such as lap winding and wave winding.

Next, the conductor wire 4 which is a conductor that forms the coil 3 for each phase will be described. The conductor wire 4 has a deformable cross-sectional shape. As shown in FIG. 5, a diameter φ (wire width D1) of the conductor wire 4 with a circular cross-sectional shape is larger than the slot opening width W1 which is the width of the radial opening portion 22b (slot opening portion) in the circumferential direction. In the present embodiment, as shown in FIG. 3. the conductor wire 4 includes the conductor element wire bundle 42 formed by gathering the plurality of conductor element wires 41, and the flexible insulating covering material 46 that covers the periphery of the conductor element wire bundle 42.

The conductor element wires 41 are linear conductors formed from copper, aluminum, or the like, for example. In the present embodiment, as shown in FIG. 4, each conductor element wire 41 has a circular shape in cross section taken in an orthogonal extending plane P (see FIG. 3) which is a plane orthogonal to an extending direction A of the conductor wire 4, and has a relatively small diameter. For example, a conductor element wire 41 with a diameter (element wire diameter) equal to or less than 0.2 mm is preferably used. In the present embodiment, in addition, a bare wire is used as the conductor element wire 41. If the conductor element wire 41 is a bare wire, the surface of the conductor such as copper, aluminum, or the like is not covered with an insulator but exposed. While an oxide film formed by oxidation of the surface of the conductor may have low electrical insulation, such an oxide film is not included in the insulator here. Thus, a wire with an oxide film formed on the surface of the conductor is also included in the conductor element wire 41 which is a bare wire. While a bare wire is used as the conductor element wire 41 in the present embodiment, an insulating film formed of an electrically insulating material such as a resin (such as a polyamide-imide resin or a polyimide resin, for example) may be formed on the surface of the conductor element wire 41. Such an insulating film is formed as a film that covers the surface of each conductor element wire 41, unlike the insulating covering material 46 to be described later.

The number of conductor element wires 41 that form the conductor element wire bundle 42 is decided in accordance with the final thickness (cross-sectional area) of the conductor wire 4 and the thickness (cross-sectional area) and the shape of each conductor element wire 41. In the present embodiment, the thickness (cross-sectional area) of each conductor wire 4 is set such that the space in each slot 22 is occupied by six conductor wires 4 as shown in FIG. 2, and the thickness (cross-sectional area) of the conductor element wire bundle 42 and the number, thickness, etc. of the conductor element wires 41 are set accordingly. In the present embodiment, as shown in FIG. 3, a plurality of conductor element wires 41 are stranded to form a single conductor element wire bundle 42. As a matter of course, a plurality of conductor element wires 41 may be bundled without being stranded to form a single conductor element wire bundle 42.

The insulating covering material 46 is a flexible electrically insulating member, and provided to cover the periphery of the conductor element wire bundle 42. Here, the periphery of the conductor element wire bundle 42 is the periphery (outer periphery) of a cross section of the conductor element wire bundle 42 taken in the orthogonal extending plane P, and does not include end portions of the conductor element wire bundle 42 in the extending direction A. That is, the insulating covering material 46 is provided to cover the entire periphery of the conductor element wire bundle 42. It should be noted, however, that in the case where a connection portion is provided at an end portion of the conductor element wire bundle 42 in the extending direction A to electrically connect one conductor wire 4 to another conductor wire 4 or another conductor, the insulating covering material 46 is provided to cover the entire conductor element wire bundle 42 along the extending direction A excluding the connection portion. The extending direction of the conductor element wire bundle 42 and the extending direction of the conductor wire 4 are the same as each other, and therefore indicated by the same symbol “A”.

A flexible and electrically insulating material is used for the insulating covering material 46. Examples of the material include various synthetic resins such as fluorine-based resins, epoxy-based resins, and polyphenylenesulfides. Here, the term “flexible” refers to the nature that allows bending and warping. The insulating covering material 46 according to the present embodiment may only be elastic to such a necessary and sufficient degree that the conductor wire 4 can be wound around the stator core 2 by bending and warping the conductor wire 4, and may not be excessively elastic. Here, the term “elastic” refers to the nature that allows expansion and contraction. Here, in particular, the insulating covering material 46 is not required to be particularly elastic in the radial direction. For example, the insulating covering material 46 may be formed of a material with a circumferential length after expansion of 130% or less, preferably 120% or less, further preferably 110% or less, with reference to the circumferential length in a perfect circle state with no external force applied. In the present embodiment, such an insulating covering material 46 is formed from a flexible sheet-shaped or tubular material that wraps the periphery of conductor element wire bundle 42.

In the present embodiment, as described above, the conductor element wires 41 have a circular shape in cross section orthogonal to the extending direction. Therefore, as shown in FIG. 4, a gap G is formed between the plurality of conductor element wires 41 forming the conductor element wire bundle 42. In addition, a gap G is also formed between an inner circumferential surface 46a of the insulating covering material 46 and the conductor element wire bundle 42. In this way, the conductor wire 4 is formed to have a gap G inside the insulating covering material 46.

In the thus structured conductor wire 4, the plurality of conductor element wires 41 are movable relative to each other in the insulating covering material 46. Therefore, the shape of the conductor wire 4 in cross section orthogonal to the extending direction A can be deformed relatively freely. That is, the conductor wire 4 is configured such that the cross-sectional shape of the conductor wire 4 is easily deformable because of the gap G formed inside the insulating covering material 46. Thus, the conductor wire 4 is not only easily warped along the extending direction A (longitudinal direction) to be deformed, but also easily deformable in cross section orthogonal to the extending direction A. The structure of the conductor wire 4 with excellent, flexibility will be described in detail later.

In the present embodiment, as shown in FIG. 5, the diameter φ (wire width D1) of the conductor wire 4 (4N) with the conductor wire 4 having a circular shape in cross section orthogonal to the extending direction A is larger than the slot opening width W1 which is the width of the radial opening portion 22b (slot opening portion) in the circumferential direction C. Meanwhile, at least a minor axis length D9 of the cross-sectional shape of the conductor wire 4 (4F) at the time when the conductor wire 4 is maximally flat is equal to or less than the slot opening width W1. That is, the conductor wire 4 with a deformable cross-sectional shape is flexible enough to be flattened such that the wire width of the conductor wire 4 can become equal to or less than the slot opening width W1, and the wire width D is variable. The slot 22 according to the present embodiment is a semi-open slot. As described above, the maximum slot width W9, which is the largest value of the slot width W in the circumferential direction C, is larger than the slot opening width W1. In this case, the diameter φ (wire width D1) of the conductor wire 4 with a circular cross-sectional shape is preferably equal to or less than the maximum slot width W9.

In general, a flexible object becomes stable when it is circular or spherical. In many cases, an elongated object such as the conductor wire 4 becomes stable when it is circular in cross section orthogonal to the longitudinal direction (extending direction). Thus, with no external force applied to the conductor wire 4, the cross-sectional shape of the conductor wire 4 in the slot 22 is likely to be circular. As described later, the space factor of the conductor wire 4 in the slot 22 can be enhanced by applying an external force to the conductor wire 4 in the slot 22. In consideration of what has been stated above, it is desirable that the conductor wire 4 should tend to be in a stable shape with no external force applied and be freely deformable. Therefore, it is desirable that the circumferential width (slot width W) of the slot 22, even only at a portion of the slot 22, should be larger than the diameter φ (wire width D1) of the conductor wire 4 with a circular cross-sectional shape. That is, the diameter φ (wire width D1) of the conductor wire 4 with a circular cross-sectional shape is preferably equal to or less than the maximum slot width W9.

In this case, in addition, a major axis length D5 of the conductor wire 4 (4F) at the time when the conductor wire 4 is maximally flat is preferably equal to or more than the maximum slot opening width W9 (see FIG. 5). That is, the conductor wire 4 which is flexible and has a deformable cross-sectional shape preferably can be flattened such that the wire width of the conductor wire 4 is equal to or less than the slot opening width W1 and can be widened (flattened in a direction different from the direction in which the conductor wire 4 is flattened such that the wire width of the conductor wire 4 is equal to or less than the slot opening width W1) such that the wire width of the conductor wire 4 is equal to or more than the maximum slot width W9. For example, defining the flattening direction (the direction corresponding to the narrow wire width) in which the conductor wire 4 is flattened such that the wire width of the conductor wire 4 is equal to or less than the slot opening width W1 as a first flattening direction, flattening in a direction (second flattening direction) orthogonal to the first flattening direction refers to widening. Here, an orthogonal direction allows deviation of about ±45 degrees with respect to the perfectly orthogonal direction.

As described above, the gap in the slot 22 can be reduced to enhance the space factor of the conductor wire 4 by applying an external force to the conductor wire 4 in the slot 22 to deform the cross-sectional shape of the conductor wire 4. Here, if the major axis length D5 of the conductor wire 4 at the time when the conductor wire 4 is maximally flat is equal to or more than the maximum slot width W9, a space in the slot 22 in the circumferential direction C can be filled with the conductor wire 4 by applying an external force from one direction. For example, a plurality of conductor wires 4 can be arranged in a row in the radial direction by applying an external force (pressing force) along the radial direction R from the radial opening portion 22h (slot opening portion) toward the depth direction. In this event, the cross-sectional shape of the conductor wires 4 is varied substantially exclusively in one direction (circumferential direction), and thus is not varied significantly This enables the conductor wires 4 to be disposed along the radial direction R. In addition, the conductor wires 4 can be disposed in substantially the same arrangement in each slot 22.

Subsequently, the arrangement of the conductor wires 4 with respect to the stator core 2 will be described. As shown in FIG. 2, a plurality of (in the example, six) conductor wires 4 are disposed in each of the plurality of slots 22 of the stator core 2 with adjacent ones of the plurality of conductor wires 4 contacting each other. In the present embodiment, all of the plurality of conductor wires 4 in each slot 22 are disposed in a row along the radial direction R at the same position in the circumferential direction C. That is, the plurality of conductor wires 4 are stacked in the radial direction R of the core reference surface 21 in the slot 22, and the stator 1 according to the present embodiment has a multi-layer winding structure (in the example, 6-layer winding structure). Each conductor wire 4 may be considered to be disposed in each slot 22 to extend linearly with the extending direction A corresponding to a direction parallel with the axial direction L along the slot 22.

Here, the number of conductor wires 4 disposed in each slot 22 is counted with focus on only portions of the conductor Wires 4 disposed in each slot 22. In the present embodiment, the conductor wire 4 which forms one stretch of wire when removed from the stator core 2 is wound six times in the same slot 22 so that six conductor wires 4 are disposed in each slot 22. Alternatively, the conductor wire 4 which forms two stretches of wire when removed from the stator core 2 may be wound three times each in the same slot 22, or the conductor wire 4 which forms three stretches of wire when removed from the stator core 2 may be wound twice each in the same slot 22, so that six conductor wires 4 are disposed in each slot 22. The six conductor wires 4 in each slot 22 may form six independent wires when removed from the stator core 2. In any case, the conductor wire 4 may be wound around the stator core 2 such that a plurality of (in the example, six) conductor wires 4 are disposed in each of the plurality of slots 22 of the stator core 2.

As described above, the conductor wire 4 is a flexible conductor wire whose shape in cross section taken in the orthogonal extending plane P is easily deformable. Thus, the conductor wire 4 can be deformed in each slot 22 in accordance with the shape of the slot 22 to reduce the size of a gap between the plurality of conductor wires 4 and a gap between the conductor wires 4 and the inner wall surface 22a of the slot 22, thereby enhancing the space factor of the conductor wire 4. In order to reduce the site of the gaps, adjacent ones of the conductor wires 4 contact each other in each slot 22. More particularly, as shown in FIG. 2, each of the plurality of conductor wires 4 has a contact surface shaped along the contact surface of an adjacent one of the conductor wires 4 so that the conductor wires 4 are in surface contact with each other through the contact surfaces. In the present embodiment, in addition, all of the plurality of conductor wires 4 disposed in each slot 22 have portions extending along the inner wall surface 22a of the slot 22 to be in surface contact with the inner wall surface 22a through such portions. That is, each conductor wire 4 has a contact surface that extends in parallel with the inner wall surface 22a and that is in surface contact with the inner wall surface 22a.

The contact surface of the conductor wire 4 described above is formed by deforming each of the plurality of conductor wires 4 which is pressed against the inner wall surface 22a or another conductor wire 4 in the slot 22. In the present embodiment, the plurality of conductor wires 4 are disposed to keep their shape in a state in which the conductor wires 4 are pressed from the radial opening portion 22b side in each slot 22. That is, the plurality of conductor wires 4 are deformed compared to the natural state in which no external force is applied at all to the conductor wires 4.

In the present embodiment, in addition, the thickness of each conductor wire 4 (area in cross section taken in the orthogonal extending plane P) is set such that the space in each slot 22 is filled with a plurality of (in the example, six) conductor wires 4. Thus, with the plurality of conductor wires 4 accommodated in the slot 22, as shown in FIG. 2, the conductor wires 4 contact each other, or each conductor wire 4 contacts the inner wall surface 22a of the slot 22, to be deformed such that a gap between the plurality of conductor wires 4 and a gap between the conductor wire 4 and the inner wall surface 22a of the slot 22 are very small. In this state, the shape obtained by combining the cross-sectional shapes of the plurality of conductor wires 4 matches the shape of the slot 22 in cross section orthogonal to the axial direction L.

In the present embodiment, the inner wall surface 22a of each slot 27 has two flat surfaces that are not parallel with each other but that face each other, and a surface that is arcuate in cross section and that extends in the axial direction L. If a linear conductor with a fixed cross-sectional shape and a relatively large wire width is disposed in the slot 22, the size of the gap between the linear conductor and the inner wall surface 22a of the slot 22 tends to be increased. According to the configuration of the present embodiment, however, the cross-sectional shape of each conductor wire 4 is deformed in accordance with the shape of the inner wall surface 22a of the slot 22, thereby facilitating reducing the size of the gap between the conductor wire 4 and the inner wall surface 22a. With the cross-sectional shape of each conductor wire 4 deformed in this way, adjacent conductor wires 4 tightly contact each other, or each conductor wire 4 and the inner wall surface 22a tightly contact each other, to result in a reduction in size Of the gap. In this event, the cross-sectional shape of each of the plurality of conductor wires 4 is varied diversely with the cross-sectional shape of each conductor wire 4 deformed in accordance with the shape of the inner wall surface 22a, or with the conductor wires 4 with an easily deformable cross-sectional shape pressed against each other. Therefore, the plurality of conductor wires 4 disposed in the same slot 22 may differ from each other in cross-sectional shape.

In order for the plurality of conductor wires 4 to be accommodated in the slot 22 with a reduced gap as described above, the plurality of conductor wires 4 preferably keep their shape in a state in which the conductor wires 4 are pressed from the radial opening portion 22b side of the slot 22 in each slot 22. In the present embodiment, in order to prevent the conductor wires 4 from coming out of the radial opening portion 22b, a blocking member 25 is disposed at the radial opening portion 22b of the slot 22 to block the radial opening portion 22b. Such a member is often referred to as a wedge. The blocking member 25 contacts outer surfaces, in the radial direction R, of the circumferential projecting portions 23b formed at the distal end portions of the teeth 23 to support the conductor wires 4 from the inner side in the radial direction R. Therefore, the blocking member 25 has a width in the circumferential direction C larger than the slot opening width W1 of the radial opening portion 22b of the slot 22, and a length in the axial direction L equal to or more than the length of the stator core 2 in the axial direction L. The blocking member 25 is preferably formed from a material with relatively large magnetic resistance and electric resistance such as various synthetic resins. Consequently, the plurality of conductor wires 4 are disposed to keep their shape in a state in which the conductor wires 4 are pressed from the radial opening portion 22b side. In one preferred embodiment, no blocking member 25 is disposed at the radial opening portion 22b. In this case, for example, the conductor wire 4 that is the closest to the radial opening portion 22b is deformed in the slot 22 so as to have a diameter larger in the circumferential direction C than the slot opening width W1 of the radial opening portion 22b to be able to serve as the blocking member 25.

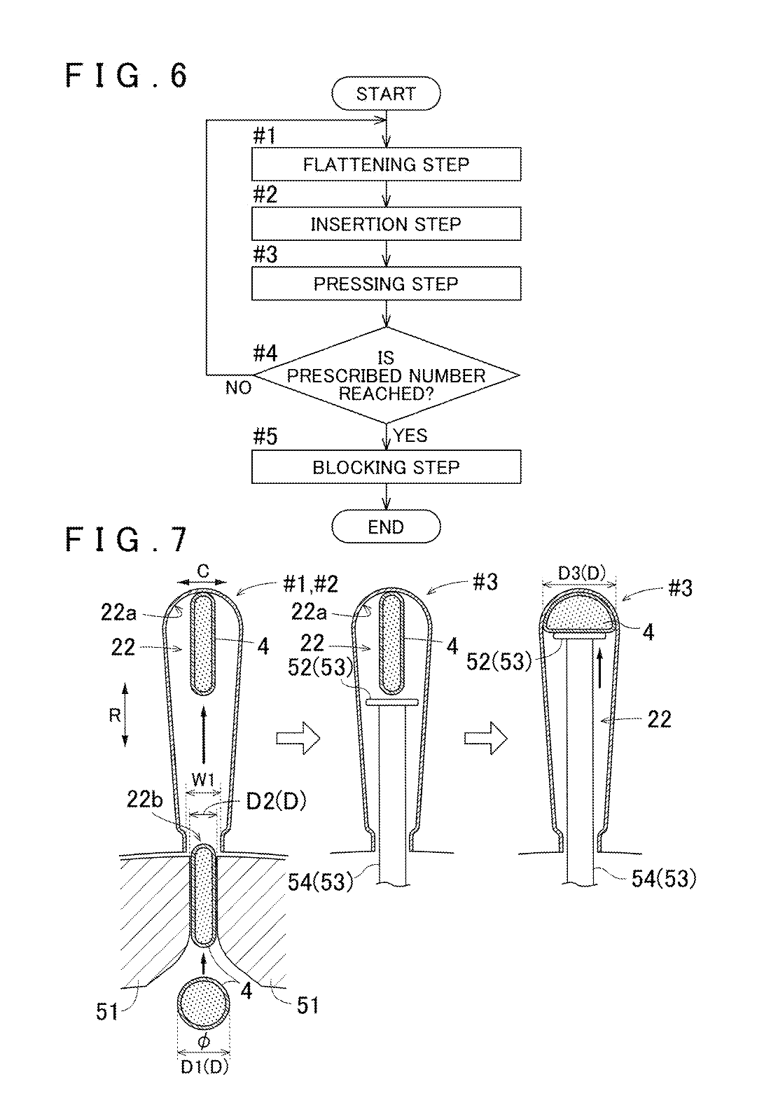

Subsequently, the manufacturing method for the stator 1 as a coil unit will be described with additional reference to the flowchart of FIG. 6. A series of processes for manufacturing the stator 1 includes at least an insertion step #2 in which the conductor wire 4 is inserted into the slot 22 from the radial opening portion 22b (slot opening portion), and a pressing step #3 in which the conductor wire 4 inserted into the slot 22 is pressed to deform the cross-sectional shape of the conductor wire 4. The diameter φ (wire width D1) of the conductor wire 4 with a circular cross-sectional shape is larger than the slot opening width W1. Thus, in the insertion step #2, the conductor wire 4 is inserted into the slot 22 from the radial opening portion 22b (slot opening, portion) with the circumferential wire width, which is the wire width D in a direction parallel with the slot opening width W1, equal to or less than the slot opening width W1. In the subsequent pressing step #3, the conductor wire 4 inserted into the slot 22 is pressed in the depth direction, which is opposite to the opening direction. Then, the cross-sectional shape of the conductor wire 4 is deformed such that the wire width D in the circumferential direction C becomes larger than the wire width D in the circumferential direction C at the time of insertion of the conductor wire 4 into the radial opening portion 22b (slot opening portion) in the insertion step #2. Prior to the insertion step #2, in addition, a flattening step #1 in which the conductor wire 4 is deformed such that the wire width D in at least one direction corresponding to the wire width D in the circumferential direction C becomes equal to or less than the slot opening width W1 is preferably performed.

The insertion step #2 and the pressing step #3 or the flattening step #1 to the pressing step #3) described above are repeated until the number of conductor wires 4 arranged in the slot 22 reaches a prescribed number (in the present embodiment, “6”). It is determined in a repetition determination process 44 whether or not the prescribed number is reached. Here, when the space in the slot 22 is tilled with a plurality of (six) conductor wires 4, the blocking member 25 is disposed at the radial opening, portion 22b of the slot 22 to block the radial opening portion 22b (blocking process #5). As described above, the blocking member 25 can be dispensed with, in which case the blocking process #5 can be omitted. In this way, the conductor wires 4 are inserted one at a time into the slot 22 in the insertion step #2 so that a plurality of conductor wires 4 are stacked in the radial direction R of the core reference surface 21 in the slot 22.

FIG. 7 schematically shows a series of processes for one slot. While only one of the plurality of slots 22 of the stator core 2 is shown in FIG. 7, the same processes are also executed for the other slots 22. The schematic illustration on the left side of FIG. 7 shows the flattening step #1 and the insertion step #2. As shown in FIG. 7, the conductor wire 4 is flattened utilizing flattening jigs 51 such that the wire width D of the conductor wire 4 in the circumferential direction C becomes a wire width D2 equal to or less than the slot opening width W1. Then, the conductor wire 4 flattened to the wire width D2 in the circumferential direction C passes through the radial opening portion 22b to be inserted into the slot 22.

In one aspect, the insertion step #2 may be executed by pushing the conductor wire 4 in the depth direction along the radial direction R using an insertion jig (not shown). Alternatively, the conductor wire 4 may be inserted into the slot 22 from the radial opening portion 22b by holding portions of the conductor wire 4 located outside the stator core 2 at both ends of the stator core 2 in the axial direction L using an insertion jig (not shown) and moving the insertion jig in the depth direction along the radial direction R. In any case, the conductor wire 4 is inserted to the deepest possible point inside the slot 22 in the insertion step #2. That is, in the present embodiment, the conductor wire 4 initially inserted into the slot 22 is inserted to the inner wall surface 22a which is arcuate in cross section. Each of the secondly and subsequently inserted conductor wires 4 is inserted to a position at which the conductor wire 4 contacts the insulating covering material 46 of the already inserted conductor wire 4.

The schematic illustrations in the middle and on the right side of FIG. 7 show the pressing step #3. The schematic illustration in the middle of FIG. 7 shows a state immediately before pressing of the conductor wire 4 is started in the pressing step #3, and the schematic illustration on the right side of FIG. 7 shows a state at the time when pressing of the conductor wire 4 is completed. In the pressing step #3, the cross-sectional shape of the conductor wire 4 is deformed such that the wire width D of the conductor wire 4 in the circumferential direction becomes a wire Width D3 Which is larger than the slot opening width W1. Therefore, a pressing jig 53 for pressing is preferably configured to have a pressing portion 52 that is wider in the circumferential direction C than the radial opening portion 22b (slot opening portion). As a matter of course, the pressing jig 53 having such a pressing portion 52 may not be moved into the slot 22 from the outside of the slot 22 through the radial opening portion 22b along the radial direction R. Thus, in the pressing step #3, the pressing jig 53 having such a pressing portion 52 is inserted into the slot 22 along the axial direction L of the core reference surface 21, and thereafter the conductor wire 4 is pressed in the depth direction. As a matter of course, the pressing jig 53 may be configured such that the pressing portion 52 and a pressing support portion 54 are independent members. In this case, only the pressing portion 52 may be inserted into the slot 22 along the axial direction L of the core reference surface 21. Then, the pressing support portion 54 may be inserted into the slot 22 from the outside of the slot 22 through the radial opening portion 22b along the radial direction R, and the inserted pressing support portion 54 may press the pressing portion 52 in the depth direction to press the conductor wire 4.

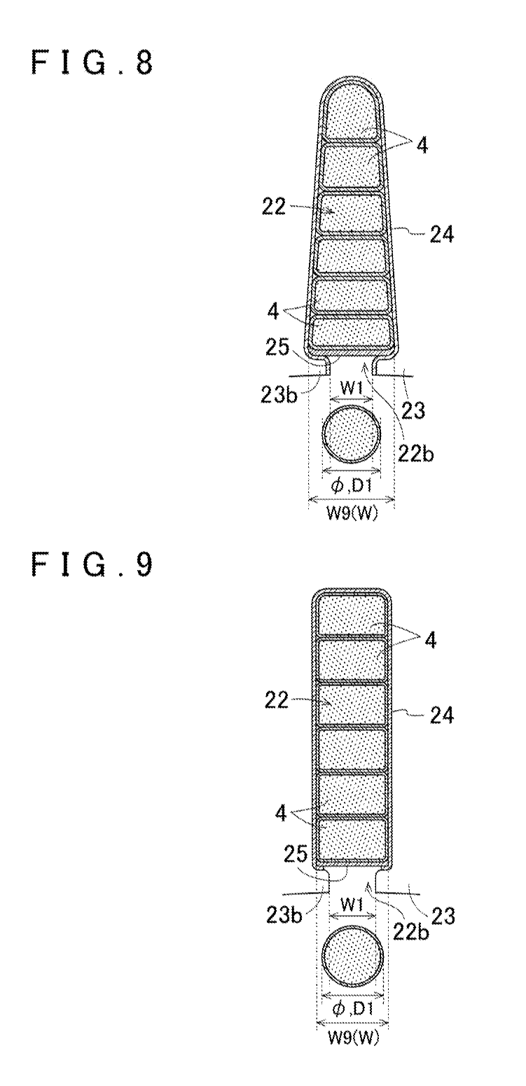

The core to which the present invention is applicable may be of a variety of shapes. In the embodiment described above, each tooth 23 is a parallel tooth with two tooth side surfaces 23a of each tooth 23 extending in parallel with each other, and each slot 22 is formed such that the width of each slot 22 in the circumferential direction C becomes gradually wider outward in the radial direction R. However, embodiments of the present invention are not limited thereto. In one preferred embodiment of the present invention, for example, the slot 22 may be formed such that the width of the slot 22 in the circumferential direction C becomes gradually narrower outward in the radial direction R as shown in FIG. 8. In this case, the inner wall surface 22a of each slot 22 has two flat surfaces formed so as to face each other in the circumferential direction C and such that the spacing therebetween becomes narrower outward in the radial direction R. In addition, the embodiment shown in FIG. 8 is suitable for application to a rotary electric machine of an outer rotor type in which a rotor is disposed outward in the radial direction R of the stator 1, and a slot 22 is formed such that the width of the slot 22 in the circumferential direction C becomes gradually narrower inward in the radial direction R.

In one preferred embodiment of the present invention, for example, a so-called parallel slot formed such that the width of the slot 22 in the circumferential direction C is constant irrespective of the position in the radial direction R may be provided as shown in FIG. 9. In this case, the inner wall surface 22a of each slot 22 has two flat surfaces formed so as to face each other in the circumferential direction C and extend in parallel with each other. In the example of FIG. 9, the slot 22 is formed to have a flat surface orthogonal to the radial direction R at a portion of the inner wall surface 22a on the outer side in the radial direction R.

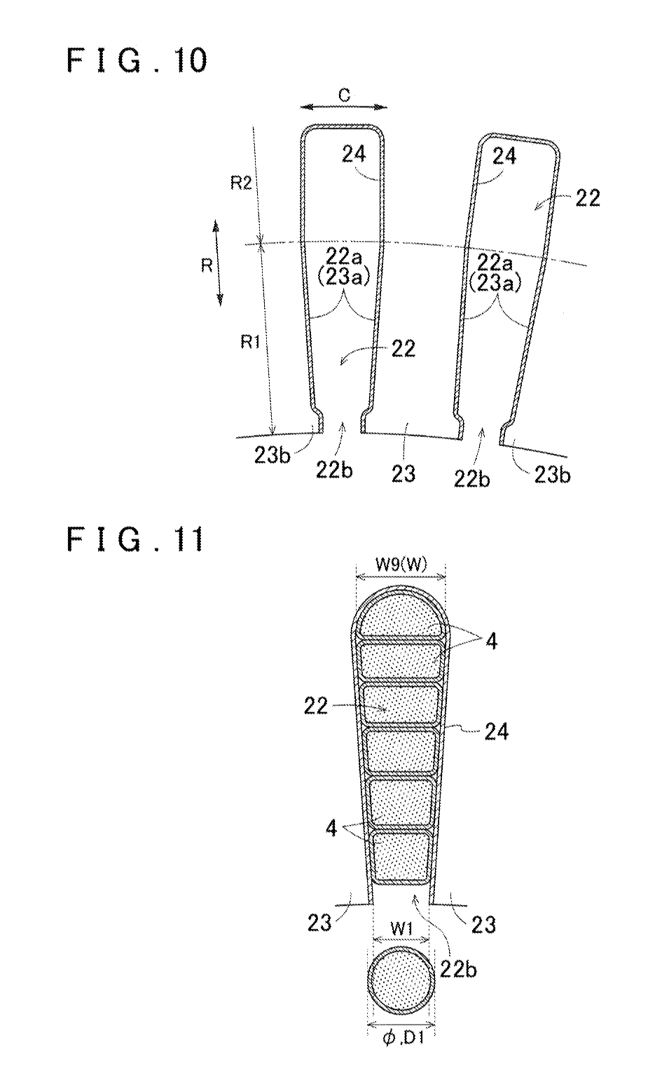

In addition, as shown in FIG. 10, the stator core 2 may be formed such that the slot 22 is shaped differently between an opening-side region R1 including the radial opening portion 22b (slot opening portion) and a depth-side region R2 on the side in the depth direction, which is opposite to the opening direction, with respect to the opening-side region R1. Specifically, in the opening-side region R1 of the stator core 2, both side surfaces, in the circumferential direction C of each tooth 23 formed between two slots 22 that are adjacent to each other in the circumferential direction C are formed to extend in parallel with each other. In the depth-side region R2 of the stator core 2, meanwhile, inner surfaces of each of the slots 22 that face each other in the circumferential direction C are formed to extend in parallel with each other.

In the embodiment described above, the slot 22 is formed as a so-called semi-open slot with each tooth 23 including the circumferential projecting portions 23b provided at the distal end portion of the tooth 23 and with the slot 22 formed to be narrow at the slot opening width W1 compared to the other portions of the slot 22. However, the present invention may be applied to a configuration in which the conductor wire 4 has a deformable cross-sectional shape, and in which the diameter (wire width D1) of the conductor wire 4 with a circular cross-sectional shape is larger than the slot opening width W1 which is the width of the radial opening portion 22b (slot opening portion) in the circumferential direction C. Thus, embodiments of the present invention are not limited to the configuration related to the embodiment described above.

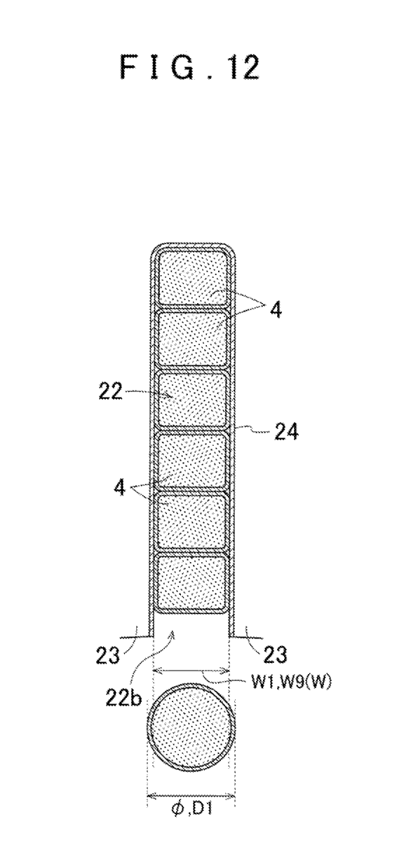

For example, as shown in FIG. 11 no circumferential projecting portions 23b may be formed at the distal end portion of each tooth 23, and the inner wall surface 22a of the slot 22 as a flat surface may extend continuously to the radial opening portion 22b. That is, in one preferred embodiment of the present invention, the slot 22 may be a so-called open slot. In this case, the blocking member 25 such as a wedge may be provided to block the radial opening portion 22b. However, no blocking member 25 may be provided as shown in FIG. 11. Similarly, the slot 22 may be an open parallel slot as shown in FIG. 12 as long as the conductor wire 4 has a diameter larger than the slot opening width W1. In the case where the slot 22 is an open parallel slot and the insertion step is performed with the wire width D of the conductor wire 4 equal to the slot opening width W1, the wire width of the conductor wire 4 may not be increased compared to the circumferential wire width at the time of insertion when the conductor wire 4 is pressed in the pressing step. However, the cross-sectional shape of the conductor wire 4 which is flexible is more or less deformed by being pressed compared to that at the time of insertion. Thus, such a configuration may also be one preferred embodiment of the present invention.

As described above, the present invention is characterized in that the conductor wire 4 has a deformable cross-sectional shape, and that the diameter φ (wire width D1) of the conductor wire 4 with a circular cross-sectional shape is larger than the slot opening width W1 which is the width of the radial opening portion 22b (slot opening portion) in the circumferential direction C. The structure of the conductor wire 4 with excellent flexibility schematically shown in FIG. 4 will be described in detail below.

As shown in FIG. 4, the density of the conductor element wires 41 disposed radially inwardly of the insulating covering material 46 (inside the insulating covering material 46) tends to be low in a radially outer region of the conductor element wire bundle 42 compared to a radially inner region thereof. Here, the conductor element wire bundle 42 is considered to have two layers according to the density of the conductor element wires 41. As shown in FIG. 4, the two layers include a first aggregated layer 43 positioned at the center portion Of the insulating covering material 46, and a second aggregated layer 44 positioned around the first aggregated layer 43.

In the first aggregated layer 43, the plurality of conductor element wires 41 tightly contact each other to be aggregated at a high density. The plurality of conductor element wires 41 included in the first aggregated layer 43 tightly contact each other so that it is difficult for the plurality of conductor element wires 41 to move relative to each other unless a large external force is applied. That is, it is difficult for the plurality of conductor element wires 41 to move relative to each other in the radial direction and the circumferential direction of the conductor wire 4. In the present embodiment, a wire having a circular shape in cross section taken in the orthogonal extending plane P is used as the conductor element wire 41. Therefore, inter-wire gaps G1 are formed as the gap G between the plurality of conductor element wires 41 forming the first aggregated layer 43 of the conductor element wire bundle 42. The inter-wire gaps G1 are formed independently of each other to be surrounded by outer surfaces of a plurality of (for example, three) conductor element wires 41, whose peripheries tightly contact each other, and to extend in the axial direction L.

In the second aggregated layer 44, the plurality of conductor element wires 41 are aggregated at some degree of density, but do not completely tightly contact each other and are aggregated at a density lower than that in the first aggregated layer 43. In-covering gaps G2 that are different from the inter-wire gaps G1 are formed as the gap G between the plurality of conductor element wires 41 forming the second aggregated layer 44 of the conductor element wire bundle 42. The in-covering gaps G2 are formed as relatively large gaps G extending in the axial direction L. The in-covering gaps G2 are formed by connecting the gaps G corresponding to the inter-wire gaps G1 in the first aggregated layer 43 to each other via spaces between the conductor element wires 41 which are adjacent to each other with a predetermined spacing therebetween. In the present embodiment, in addition, the conductor element wire bundle 42 and the insulating covering material 46 are not completely bonded to each other, but are in a non-bonded state. Therefore, the in-covering gaps G2 are formed not only between the conductor element wires 41 but also between the conductor element wire 41 and the insulating Covering material 46. The plurality of conductor element wires 41 included in the second aggregated layer 44 are spaced apart from each other via the in-covering gaps G2 so as to be easily movable relative to each other without application of a large external force. The plurality of conductor element wires 41 in the second aggregated layer 44 are movable relative to each other in at least one of the radial direction and the circumferential direction of the conductor wire 4.

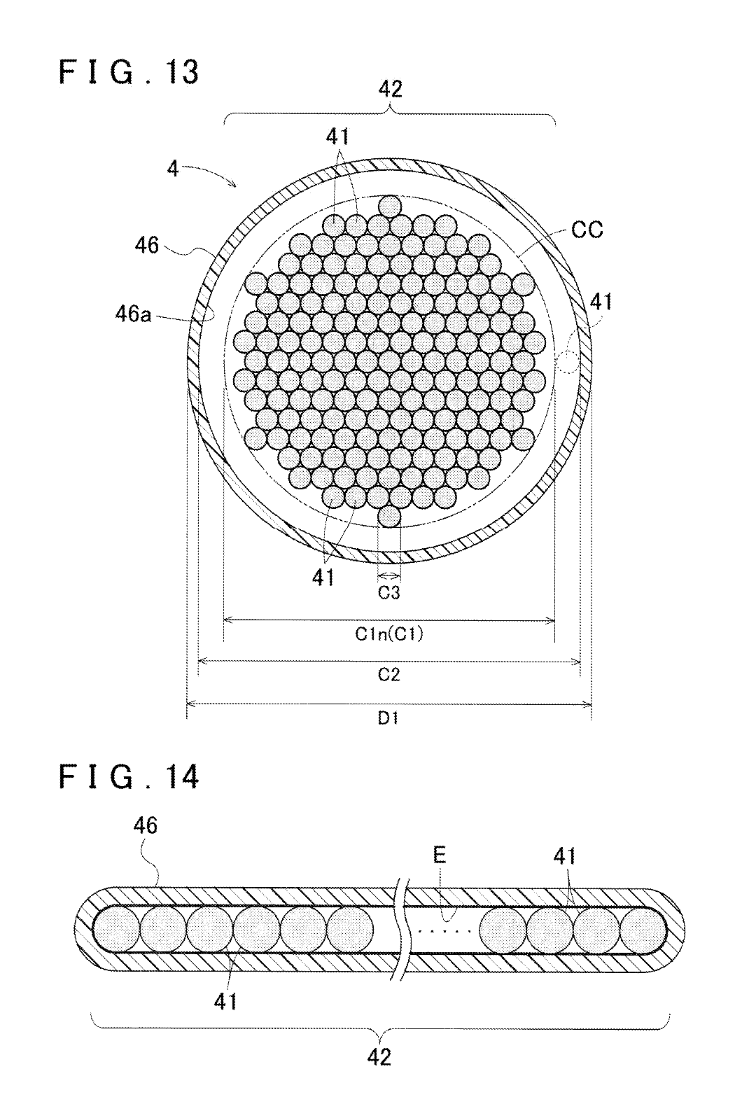

Here, an imaginary circumscribed circle CC circumscribed around the conductor element wire bundle 42 with the conductor element wires 41 which are adjacent to each other contacting each other in cross section taken in the orthogonal extending plane P is assumed. With the conductor wire 4 in a normal state, as shown in FIG. 4, the diameter (circumscribed circle diameter C1) of the imaginary circumscribed circle CC matches the inside diameter (perfect circle inside diameter C2) of the insulating covering material 46 in a perfectly circular state. That is, a relationship “C1=C2” is established. Meanwhile, as described above, the conductor wire 4 has the in-covering gaps G2 provided radially inwardly of the insulating covering material 46. Therefore, the plurality of conductor element wires 41 included in the second aggregated layer 44 are movable relative to each other so that all the conductor element wires 41 are aggregated at the center portion as shown in FIG. 13. In this case, the circumscribed circle diameter C1 of the imaginary circumscribed circle CC becomes minimum (at a minimum circumscribed circle diameter C1n). Comparing the minimum circumscribed circle diameter C1n of the imaginary circumscribed circle CC and the perfect circle inside diameter C2 of the insulating covering material 46 in cross section taken in the orthogonal extending plane P, the minimum circumscribed circle diameter C1n of the imaginary circumscribed circle CC is smaller than the perfect circle inside diameter C2 of the insulating covering material 46 as is clear from FIG. 13. That is, a relationship “C1n<C2” is established.

In one aspect, the difference between the minimum circumscribed circle diameter C1n of the imaginary circumscribed circle CC and the perfect circle inside diameter C2 of the insulating covering material 46 is preferably equal to or more than an element wire diameter C3 of the conductor element wires 41. That is, a relationship “C2−C1n≧C3” is preferably established. In the example shown in FIG. 13, the difference between a minimum circumscribed circle radius (C1n/2) of the imaginary circumscribed circle CC and a perfect circle radius (C2/2) of the insulating covering material 46 matches the element wire diameter C3 of the conductor element wires 41. Thus, in the example shown in FIG. 13, the difference between the minimum circumscribed circle diameter C in of the imaginary circumscribed circle CC and the perfect circle diameter C2 of the insulating covering material 46 is about twice the element wire diameter C3 of the conductor element wires 41. In this way, the in-covering gaps G2 with a meaningful size can be formed appropriately and reliably by reducing the minimum circumscribed circle diameter C1n of the imaginary circumscribed circle CC to be less than the perfect circle inside diameter C2 of the insulating covering material 46 by an amount exceeding the element wire diameter C3. The proportion (gap proportion) of the cross-sectional area of the in-covering gaps G2 to the cross-sectional area inside the insulating covering material 46 in cross section taken in the orthogonal extending plane P is preferably 5% to for example. In particular, gap proportions of e.g. 15% to 30% result in conductor wires 4 with a high space factor and high flexibility in which the in-covering gaps G2 are not excessively large.

In one aspect, the circumferential length of the inner circumferential surface 46a of the insulating covering material 46 is preferably equal to or less than the circumferential length of an oblong circle (circumscribed oblong circle) E circumscribed around the conductor element wire bundle 42 with all the conductor element wires 41 contacting each other and disposed in a row as shown in FIG. 14. The circumferential length of the circumscribed oblong circle E becomes longest with all the conductor element wires 41 contacting each other and disposed in a row. Hence, making the circumferential length of the inner circumferential surface 46a of the insulating covering material 46 equal to the circumferential length of the circumscribed oblong circle E in such a state allows securing the maximum degree of freedom in deforming the conductor wire 4. Conversely, making the circumferential length of the inner circumferential surface 46a of the insulating covering material 46 longer than the circumferential length of the circumscribed oblong circle E circumscribed around the conductor element wire bundle 42 uselessly increases the in-covering gaps G2, and thus is not appropriate. Thus, the circumferential length of the insulating covering material 46 can be set appropriately by setting the circumferential length of the inner circumferential surface 46a of the insulating covering material 46 within a range equal to or less than the circumferential length of the circumscribed oblong circle E circumscribed around the conductor element wire bundle 42. In other words, setting the circumferential length of the inner circumferential surface 46a of the insulating covering material 46 within a range equal to or less than the circumferential length of the circumscribed oblong circle E allows setting the size of the in-covering gaps G2 to an appropriate value to bring the gap proportion described above within a desired range.

Because the conductor wire 4 has the in-covering gaps G2 provided radially inwardly of the insulating covering material 46, the conductor element wires 41 are relatively movable in at least one of the radial direction and the circumferential direction of the conductor wire 4 in the in-covering gaps G2. In the case where the insulating covering material 46 is perfectly circular, in particular, the in-covering gaps G2 are relatively large, and the conductor element wires 41 are easily movable relative to each other in the insulating covering material 46. Because the insulating covering material 46 is flexible, in addition, the insulating covering material 46 itself is easily deformable. Consequently, the conductor wire 4 (the conductor element wire bundle 42 and the insulating covering material 46) is configured such that the shape of the conductor wire 4 in cross section taken in the orthogonal extending plane P is relatively freely deformable. That is, the conductor element wires 41 move relative to each other in the in-covering gaps G2 inside the insulating covering material 46 in accordance with deformation of the insulating covering material 46 so that the cross-sectional shape of the conductor wire 4 is easily deformable.

According to the present invention, as has been described above, it is possible to form a rotary electric machine by winding a coil conductor wire with a high space factor around a core having a plurality of slots disposed in a distributed manner in the circumferential direction of a cylindrical core reference surface.

### Other Embodiments

Other embodiments of the present invention will be described below. The configuration of each embodiment described below is not limited to its independent application, and may be applied in combination with the configuration of other embodiments unless any contradiction occurs.

(1) In the embodiment described above, the conductor wire 4 with a deformable cross-sectional shape includes the conductor element wire bundle 42 formed by gathering the plurality of conductor element wires 41, and the flexible insulating covering material 46 that covers the periphery of the conductor element wire bundle 42. However, the configuration of the conductor wire 4 is not limited to that according to the example as long as the cross-sectional shape of the conductor wire 4 is deformable. For example, the conductor wire 4 may be configured to have one conductor with a deformable cross-sectional shape provided inside the insulating covering material 46. Preferred examples of such a conductor include a conductive polymer.

(2) In the embodiment described above, the slot insulating portion 24 provided on the inner wall surface 22a of the slot 22 is formed by insulating powder coating. However, the configuration of the slot insulating portion 24 is not limited thereto. In one preferred embodiment of the present invention, for example, a slot insulating sheet may be disposed along the inner wall surface 22a of the slot 22 to form the slot insulating portion 24. Basically, the slot insulating portion 24 formed only in a region where the conductor wires 4 are disposed would be sufficient. Thus, in the case where such a slot insulating sheet is used, it is not necessary that the slot insulating sheet should be disposed at the radial opening portion 22b of the slot 22. For example, the slot 22 shown in FIG. 9 shows an example of such a slot insulating portion 24. In one preferred embodiment of the present invention, in addition, no slot insulating portion 24 may be provided at all on the inner wall surface 22a of the slot 22, although not shown. Because the outer circumferential surfaces Of the conductor wires 4 are coated with the insulating covering material 46, electrical insulation between the conductor wires 4 and the stator core 2 can be secured.

(3) In the embodiment described above, the conductor element wire brindle 42 and the insulating covering Material 46 are not bonded to each other. However, embodiments of the present invention are not limited thereto. That is, the conductor element wire bundle 42 and the insulating covering material 46 may be bonded to each other. Such a configuration may be achieved by moving the conductor element wire bundle 42 in the extending direction A while supplying an appropriate amount of a resin material for forming the insulating covering material 46 in a molten state around the conductor element wire bundle 42, for example. That is, the conductor element wire bundle 42 and the insulating covering material 46 can be bonded to each other by shaping the inner circumferential surface 46a of the insulating covering material 46 so as to have projections and recesses matching the shape of the periphery of the conductor element wire bundle 42. In this case, the gap G inside the covering is formed not between the conductor element wires 41 and the insulating covering material 46 but only between the conductor element wires 41 unlike the embodiment described above. Also in this case, however, the conductor element wires 41 are movable relative to each other utilizing the gap G formed between the conductor element wires 41, and thus the cross-sectional shape of the conductor wire 4 is easily deformable.

(4) In the embodiment described above, the plurality of slots 22 each include the radial opening portion 22b (slot opening portion) which opens inward in the radial direction R. Such a configuration is suitable for a rotary electric machine of an inner rotor type in which a rotor is disposed inward in the radial direction R of the stator 1. However, embodiments of the present invention are not limited thereto. In one preferred embodiment of the present invention, for example, the plurality of slots 22 each include the radial opening portion 22b which opens outward in the radial direction R. Such a configuration is suitable for a rotary electric machine of an outer rotor type in which a rotor is disposed outward in the radial direction R of the stator 1. In addition, the present invention is not limited to application to such radial gap rotary electric machines, and may be suitably applied to axial gap rotary electric machines. As a matter of course, the coil unit is applicable to a stator or a rotor formed as an armature, and this the present invention may be applied not only to a stator but also to a rotor.

The present invention may be applied to the manufacture of a coil unit that forms a stator or a rotor of a rotary electric machine, in which a coil conductor wire is wound around a core having a plurality of slots disposed in a distributed manner in the circumferential direction of a cylindrical core reference surface.

What is claimed is:

1. A method for manufacturing a coil unit that forms a rotary electric machine, in which a coil conductor wire is wound around a core, the core having a plurality of slots disposed in a distributed manner in a circumferential direction of a cylindrical core reference surface, the slots each having a slot opening portion that opens in an opening direction toward one side in a radial direction of the core reference surface, the method comprising:
an insertion step of inserting the coil conductor wire into the slot from the slot opening portion with a circumferential wire width of the coil conductor wire equal to or less than a slot opening width, the slot opening width being a width of the slot opening portion in the circumferential direction, the circumferential wire width being a wire width of the coil conductor wire in a direction parallel with the slot opening width, the coil conductor wire being a conductor wire with a deformable cross-sectional shape, and a diameter of the coil conductor wire with a circular cross-sectional shape being larger than the slot opening width; and
a pressing step of pressing the coil conductor wire inserted into the slot in a depth direction which is opposite to the opening direction to deform the cross-sectional shape of the coil conductor wire.

2. The manufacturing method for a coil unit according to claim 1, further comprising:
a flattening step of deforming the coil conductor wire such that the wire width of the coil conductor wire in at least one direction corresponding to the circumferential wire width becomes equal to or less than the slot opening width, the flattening step being performed prior to the insertion step.

3. The manufacturing method for a coil unit according to claim 1, wherein the pressing step includes deforming the cross-sectional shape of the coil conductor wire such that the circumferential wire width becomes larger than the circumferential wire width at a time of insertion into the slot opening portion in the insertion step.

4. The manufacturing method for a coil unit according to claim 1, wherein:
the slot has an internal space that is wider in the circumferential direction on a side in the depth direction with respect to the slot opening portion than at the slot opening portion; and
the pressing step includes deforming the cross-sectional shape of the coil conductor wire such that the circumferential wire width of the coil conductor wire is larger than the slot opening width.

5. The manufacturing method for a coil unit according to claim 1, wherein:
the slot has an internal space that is wider in the circumferential direction on a side in the depth direction with respect to the slot opening portion than at the slot opening portion; and
the pressing step includes deforming the cross-sectional shape of the coil conductor wire such that the circumferential wire width in the slot is larger than the diameter of the coil conductor wire with a circular cross-sectional shape.

6. The manufacturing method for a coil unit according to claim 5, wherein
the coil conductor wire is a conductor wire including a conductor element wire bundle formed by gathering a plurality of conductor element wires and a flexible insulating covering material that covers a periphery of the conductor element wire bundle, and a shape of the insulating covering material in cross section taken in an orthogonal extending plane is deformable, the orthogonal extending plane being orthogonal to an extending direction of the conductor element wire bundle.

7. The manufacturing method for a coil unit according to claim 6, wherein
the coil conductor wire has an in-covering gap provided radially inwardly of the insulating covering material to make the conductor element wires movable relative to each other.

8. The manufacturing method for a coil unit according to claim 1, wherein:
the slot has an internal space that is wider in the circumferential direction on a side in the depth direction with respect to the slot opening portion than at the slot opening portion; and
the pressing step includes inserting a pressing jig that is wider in the circumferential direction than the slot opening portion into the slot along an axial direction of the core reference surface, and thereafter pressing the coil conductor wire in the depth direction.

9. The manufacturing method for a coil unit according to claim 1, wherein
the insertion step includes inserting a plurality of the coil conductor wires one at a time into the slot such that the plurality of coil conductor wires are stacked in the radial direction of the core reference surface in the slot.

10. The manufacturing method for a coil unit according to claim 2, wherein
the pressing step includes deforming the cross-sectional shape of the coil conductor wire such that the circumferential wire width becomes larger than the circumferential wire width at a time of insertion into the slot opening portion in the insertion step.

11. The manufacturing method for a coil unit according to claim 10, wherein:
the slot has an internal space that is wider in the circumferential direction on a side in the depth direction with respect to the slot opening portion than at the slot opening portion; and
the pressing step includes deforming the cross-sectional shape of the coil conductor wire such that the circumferential wire width of the coil conductor wire is larger than the slot opening width.

12. The manufacturing method for a coil unit according to claim 11, wherein:
the slot has an internal space that is wider in the circumferential direction on a side in the depth direction with respect to the slot opening portion than at the slot opening portion; and
the pressing step includes deforming the cross-sectional shape of the coil conductor wire such that the circumferential wire width in the slot is larger than the diameter of the coil conductor wire with a circular cross-sectional shape.

13. The manufacturing method for a coil unit according to claim 12, wherein
the coil conductor wire is a conductor wire including a conductor element wire bundle formed by gathering a plurality of conductor element wires and a flexible insulating covering material that covers a periphery of the conductor element wire bundle, and a shape of the insulating covering material in cross section taken in an orthogonal extending plane is deformable, the orthogonal extending plane being orthogonal to an extending direction of the conductor element wire bundle.

14. The manufacturing method for a coil unit according to claim 13, wherein
the coil conductor wire has an in-covering gap provided radially inwardly of the insulating covering material to make the conductor element wires movable relative to each other.

15. The manufacturing method for a coil unit according to claim 14, wherein:
the slot has an internal space that is wider in the circumferential direction on a side in the depth direction with respect to the slot opening portion than at the slot opening portion; and
the pressing step includes inserting a pressing jig that is wider in the circumferential direction than the slot opening portion into the slot along an axial direction of the core reference surface, and thereafter pressing the coil conductor wire in the depth direction.

16. The manufacturing method for a coil unit according to claim 15, wherein
the insertion step includes inserting a plurality of the coil conductor wires one at a time into the slot such that the plurality of coil conductor wires are stacked in the radial direction of the core reference surface in the slot.

17. The manufacturing method for a coil unit according to claim 2, wherein:
the slot has an internal space that is wider in the circumferential direction on a side in the depth direction with respect to the slot opening portion than at the slot opening portion; and
the pressing step includes deforming the cross-sectional shape of the coil conductor wire such that the circumferential wire width of the coil conductor wire is larger than the slot opening width.

18. The manufacturing method for a coil unit according to claim 2, wherein:
the slot has an internal space that is wider in the circumferential direction on a side in the depth direction with respect to the slot opening portion than at the slot opening portion; and
the pressing step includes deforming the cross-sectional shape of the coil conductor wire such that the circumferential wire width in the slot is larger than the diameter of the coil conductor wire with a circular cross-sectional shape.

19. The manufacturing method for a coil unit according to claim 3, wherein:
the slot has an internal space that is wider in the circumferential direction on a side in the depth direction with respect to the slot opening portion than at the slot opening portion; and
the pressing step includes deforming the cross-sectional shape of the coil conductor wire such that the circumferential wire width of the coil conductor wire is larger than the slot opening width.

20. The manufacturing method for a coil unit according to claim 3, wherein:
the slot has an internal space that is wider in the circumferential direction on a side in the depth direction with respect to the slot opening portion than at the slot opening portion; and
the pressing step includes deforming the cross-sectional shape of the coil conductor wire such that the circumferential wire width in the slot is larger than the diameter of the coil conductor wire with a circular cross-sectional shape.
